(19) United States
(12) Patent Application Publication
(10) Pub. No.: US 2008/0295975 A1
(43) Pub. Date: Dec. 4, 2008

(54) Cordless roman shade

(76) Inventor: Tzong-Fu Lin, Taipei (TW)

Correspondence Address: BRUCE H. TROXELL, SUITE 1404, 5205 LEESBURG PIKE, FALLS CHURCH, VA, 22041, US

(21) Appl. No.: 11/806,251

(22) Filed: May 30, 2007

(51) Int. Cl. E06B 9/24

(52) U.S. Cl. 160/84.04

(57) ABSTRACT

A cordless Roman shade includes a head rail internally provided with a tension lifting mechanism for providing a balancing force or a tension force; a shade connected at an upper portion to the head rail and including a plurality of horizontal cells; a plurality of lines associated with the shade and controlled by the tension lifting mechanism to rewind or release, so as to lift or lower the shade to a desired height; and at least one bracing system mounted on the lowest cell of the shade to stretch open and thereby stiffen the lowest cell. A user may apply an upward or downward force at the stiffened lowest cell to lift or lower the shade.

### FIELD OF THE INVENTION

The present invention relates to a Roman shade, and more particularly, to a cordless Roman shade that could be lifted or lowered to different heights without the need of using lift cords.

### BACKGROUND OF THE INVENTION

Window shades are used in modern living to shut out light and protect privacy. FIG. 1 shows a conventional Roman shade that includes a head rail 10 and a fabric shade 11 connected to and hung from a bottom of the head rail 10. A plurality of braking members 12 is mounted to the bottom of the head rail 10, and a plurality of lift cords 13 are passed through the braking members 12. The fabric shade 11 is formed with a plurality of horizontally extended folds 14 to thereby divide the shade 11 into a plurality of horizontal cells 15. Whereby, the fabric shade 11 forms a plurality of droops when it is lifted. At least one row of holes or rings 16 is longitudinally provided on the horizontal folds 14, so that at least one lift cord 13 may be extended through the row of holes or rings with a first end 17 of the lift cord 13 fastened to the lowest hole or ring 16 in the row and a second end 18 accessible from one side of the shade 11. Whereby, when the second end 18 of the lift cord 13 is pulled, the fabric shade 11 is brought to lift or lower.

Since the second end 18 of the lift cord 13 is accessible from one side of the shade 11, a small child might curiously or unexpectedly wind the lift cord 13 around its neck to result in an accident. The exposed lift cord 13 therefore forms a potentially dangerous threaten to small children, and requires improvement in design.

There are various types of window shades, such as Venetian blind, pleated shade, Roman shade, etc. There are also many patented inventions teaching cordless window shades. However, the cordless window shades of the prior art are applied to Venetian blinds and pleated shades only. The mechanisms for the conventional cordless window shades are useless in terms of the Roman shade because the shade 11 of the Roman shade is made of a soft material and the lowest cell 15 of the shade 11 fails to transmit an upward pull applied thereto to the whole shade 11 for lifting the shade 11.

It is therefore tried by the inventor to develop a bracing system to stretch open and thereby stiffen the lowest cell of the shade for a Roman shade, allowing the Roman shade to be lifted or lowered without the need of a lift cord.

### SUMMARY OF THE INVENTION

A primary object of the present invention is to provide a cordless Roman shade, which includes at least one bracing system mounted on a lowest one of a plurality of horizontal cells of the shade thereof, so that a user may lift or lower the shade to different height simply by pulling or pushing the shade at the lowest cell without the need of operating lift cords.

Another object of the present invention is to provide a cordless Roman shade, which may be folded to occupy only a very small volume to facilitate convenient packaging and/or storage of the Roman shade.

To achieve the above and other objects, the cordless Roman shade according to the present invention includes a head rail internally provided with a tension lifting mechanism for providing a balancing force or a tension force; a shade connected at an upper portion to the head rail and including a plurality of horizontal cells; a plurality of lines associated with the shade and controlled by the tension lifting mechanism to rewind or release, so as to lift or lower the shade to different desired heights; and at least one bracing system mounted on the lowest cell of the shade to stretch open and thereby stiffen the lowest cell. A user may lift or lower the shades imply by applying an upward or downward force at the stiffened lowest cell.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional Roman shade;

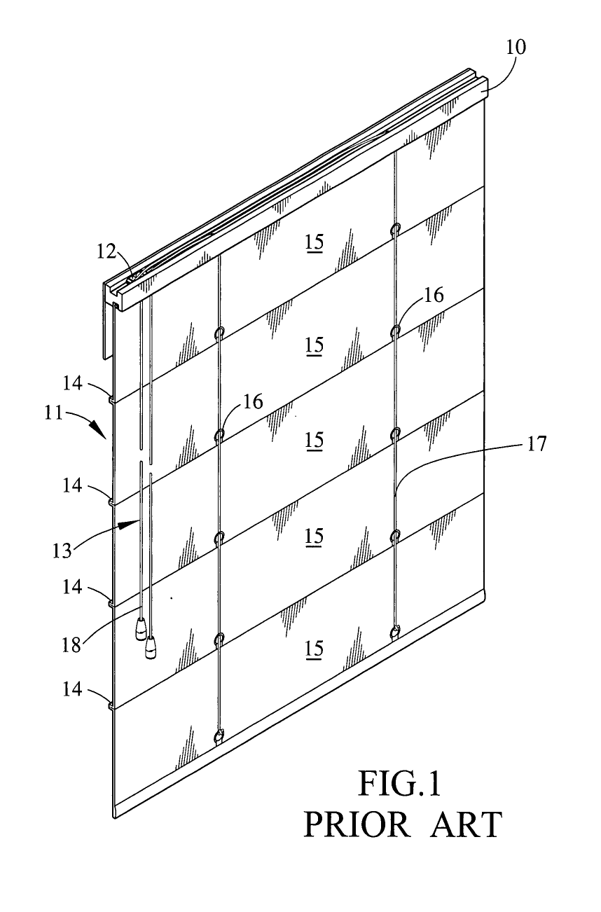

FIG. 2 is a perspective view of a cordless Roman shade according to a first embodiment of the present invention;

FIG. 3 is an exploded view of FIG. 2;

FIG. 4 is an exploded perspective view of a bracing system employed in the cordless Roman shade of FIG. 2;

FIG. 5 shows the cordless Roman shade of FIG. 2 in a fully lowered state with a lowest cell thereof being stiffened by the bracing system of FIG. 4;

FIG. 6 shows the cordless Roman shade of FIG. 2 in a fully lifted state;

FIG. 7 is a perspective view of a cordless Roman shade according to a second embodiment of the present invention; and

FIG. 8 shows the cordless Roman shade of FIG. 7 in a fully lowered state with a lowest cell thereof being stiffened by a bracing system.

### DETAILED DESCRIPTION OF THE PREFERRED EMBODIMENTS

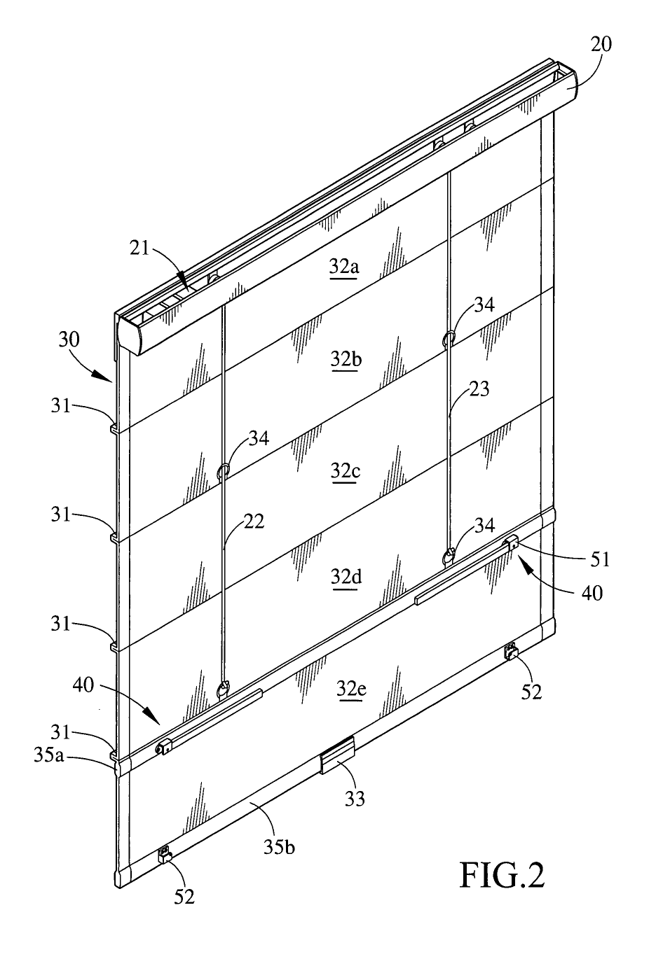

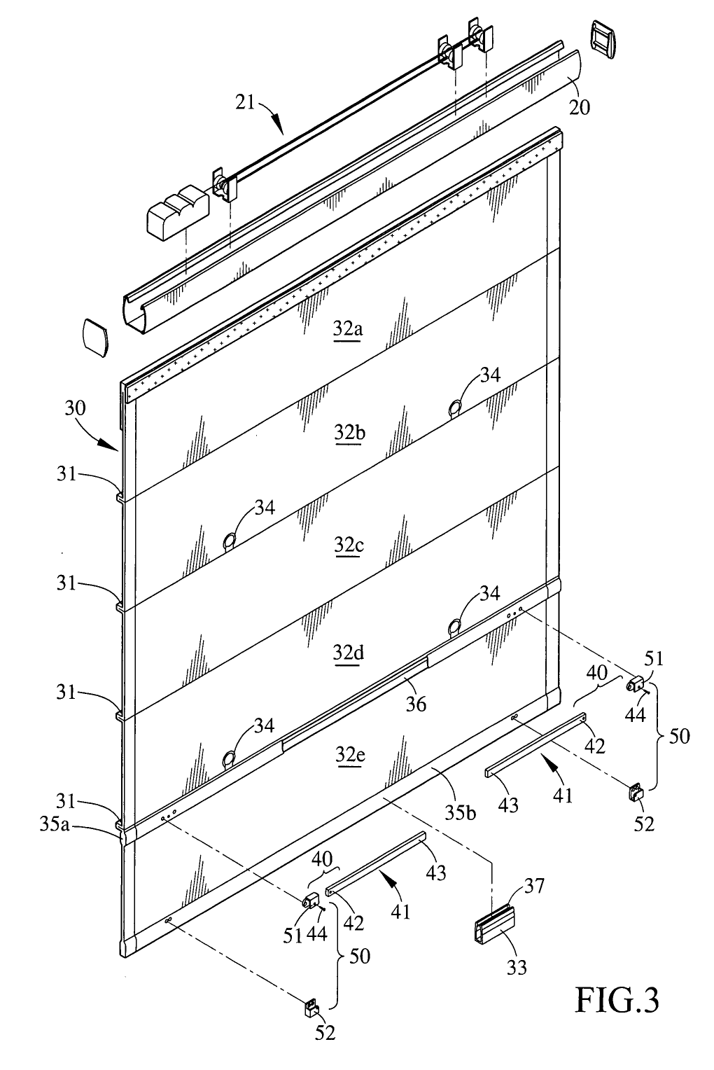

Please refer to FIGS. 2 and 3 that are assembled and exploded perspective views, respectively, of a cordless Roman shade according to a preferred embodiment of the present invention. As shown, the cordless Roman shade of the present invention includes a head rail 20, a shade 30, and at least one bracing system 40. The head rail 20 is internally provided with a tension lifting mechanism 21 for providing a balancing force or a tension force to lift or lower the shade 30. The tension lifting mechanism 21 has been disclosed in U.S. patent application Ser. No. 11/324,404 filed by the same applicant. With a force applied by hand on the shade 30, a spring of the tension lifting mechanism 21 is compressed and then released to reach a balance of forces for multiple lines 22, 23 associated with the shade 30 to rewind or release, so that the shade 30 is lifted or lowered to a desired height.

The shade 30 includes a plurality of horizontal cells 32a, 32b, 32c, 32d, and 32e from top to bottom. A horizontal fold 31 is formed between any two adjacent cells of 32a, 32b, 32c, 32d, and 32e by sewing, for example. The lowest horizontal cell 32e of the shade 30 includes an upper hem 35a and a lower hem 35b, in each of which a rigid slat 36 is provided. At least one row of lift rings 34 is associated with the shade 30. The lines 22, 23 are separately extended through one row of lift rings 34 to fasten to a lowest lift ring 34 in the row. In the present invention, the lift rings 34 are individually associated with one of the horizontal folds 31 and the upper hem 35a of the lowest cell 32e. The shade 30 is detachably connected at an upper portion to the head rail 20 using a self-adhesive device.

The at least one bracing system 40 is mounted on the lowest horizontal cell 32e, and includes a brace 41 and a fixing unit 50. The brace 41 has a first end 42 and a second end 43, and is connected at the first end 42 to the upper hem 35a of the cell 32e via a supporting pin 44, such that the brace 41 is pivotally turnable about the supporting pin 44.

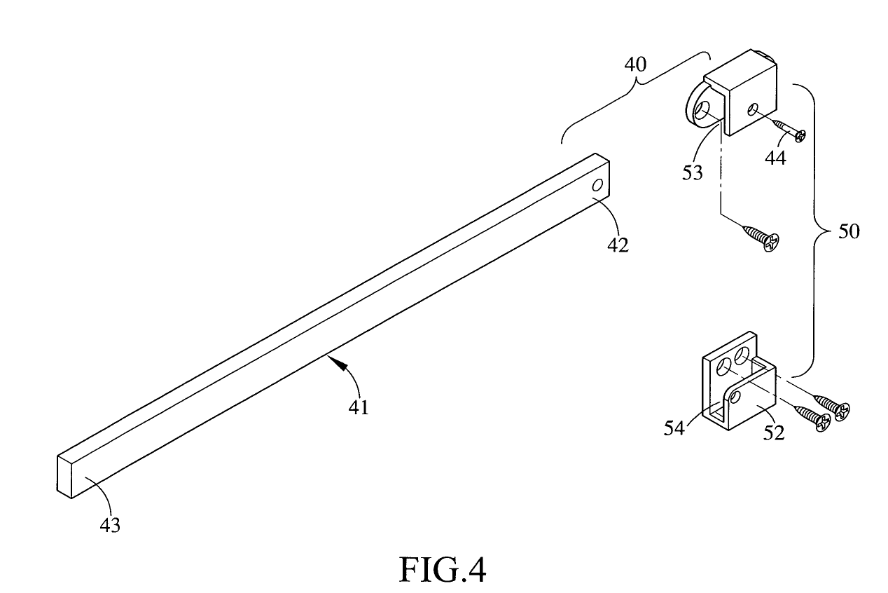

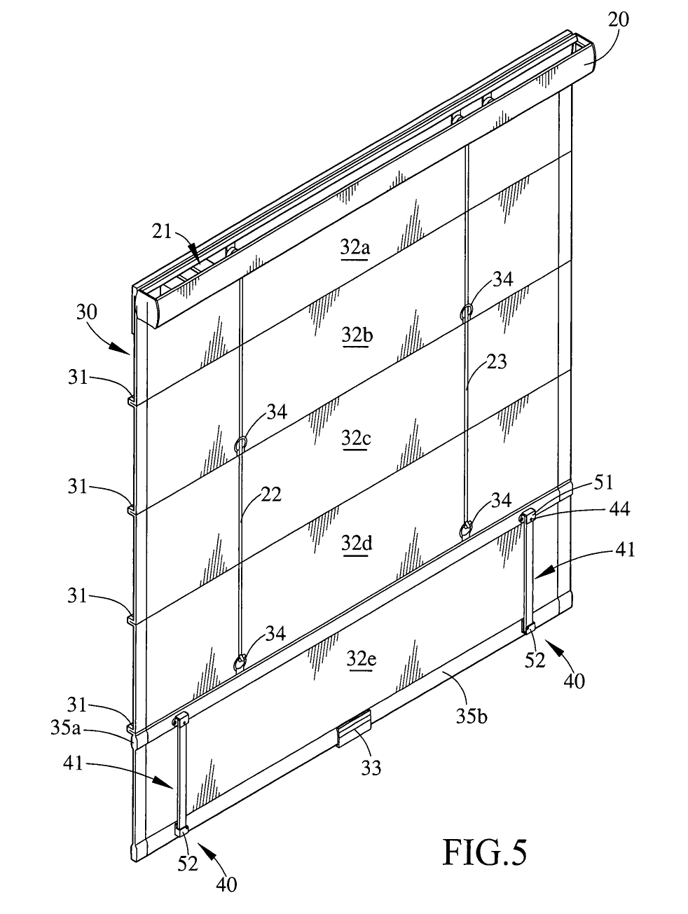

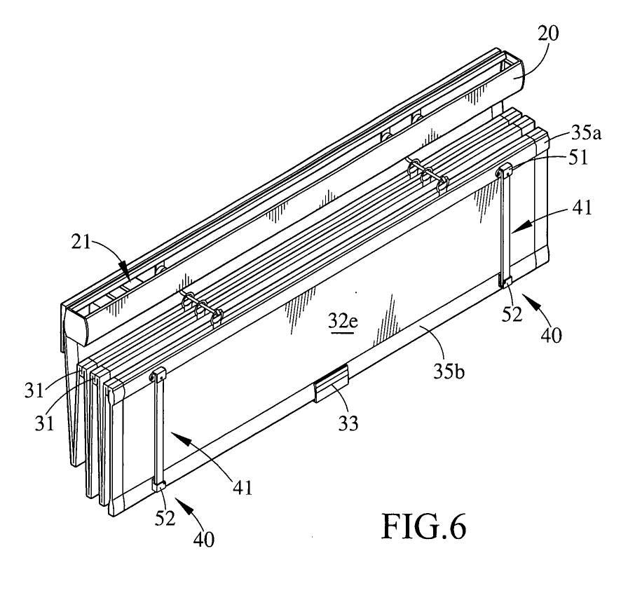

As can be clearly seen from FIGS. 3 and 4, the fixing unit 50 includes a fixing seat 51 mounted to the upper hem 35a of the cell 32e, and a receiving seat 52 mounted to the lower hem 35b of the cell 32e. It is noted the fixing seat 51 and the receiving seat 52 have a common axis. The first end 42 of the brace 41 is received in and connected via the supporting pin 44 to an inner space 53 defined in the fixing seat 51, so that the brace 41 is turnable about the supporting pin 44 relative to the fixing seat 51. When the brace 41 is downward turned from a horizontal position as shown in FIG. 2 toward the receiving seat 52, the second end 43 of the brace 41 is finally moved into an open slot 54 on the receiving seat 52. At this point, the brace 41 longitudinally stretches open the cell 32e as shown in FIG. 5, so that the cell 32e possesses some extent of stiffness. When a user manually applies an upward or a downward force on the stiffened cell 32e, the force is transmitted to the shade 30 as an upward or downward acting force, which works with the tension lifting mechanism 21 to rewind or release the multiple lines 22, 23, so that the shade 30 is lifted as shown in FIG. 6, or lowered as shown in FIG. 5.

When the second end 43 of the brace 41 is separated from the open slot 54 of the receiving seat 52, and the brace 41 is turned about the first end 42 to the horizontal position in parallel with the upper hem 35a of the cell 32e as shown in FIG. 2, the cell 32e is returned to the soft state and may be folded, allowing the whole cordless Roman shade of the present invention to be conveniently packaged or stored without occupying too much space.

The shade 30 may be further provided on the cell 32e with a bracket 33, which has an upward opening 37 adapted to engage with the lower hem 35b of the cell 32e, so that a user may grip the cell 32e at the bracket 33 to easily pull or push the shade 30 downward or upward, respectively.

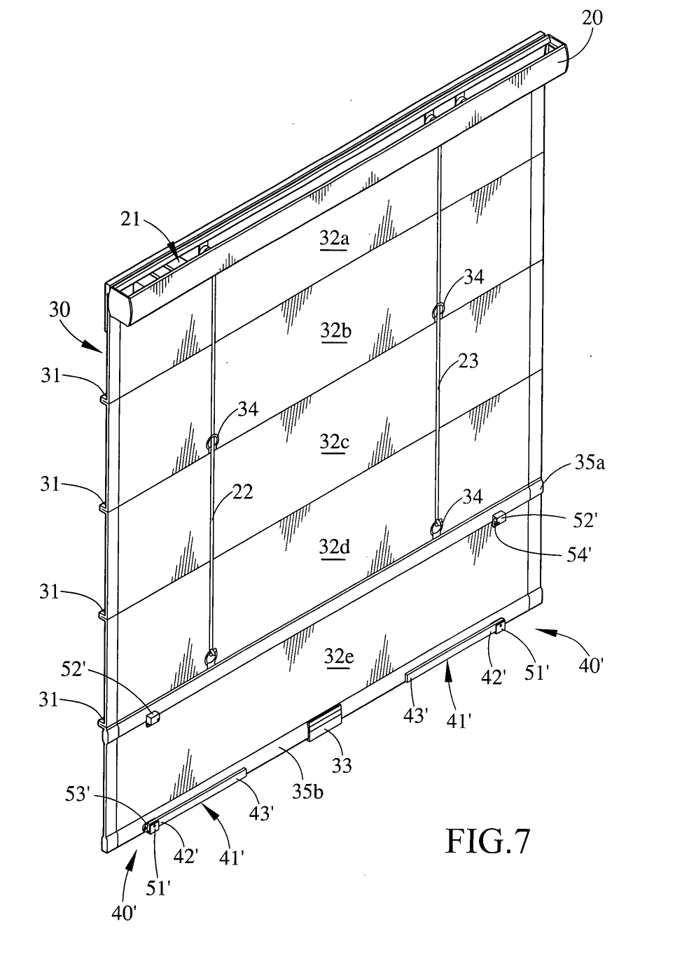

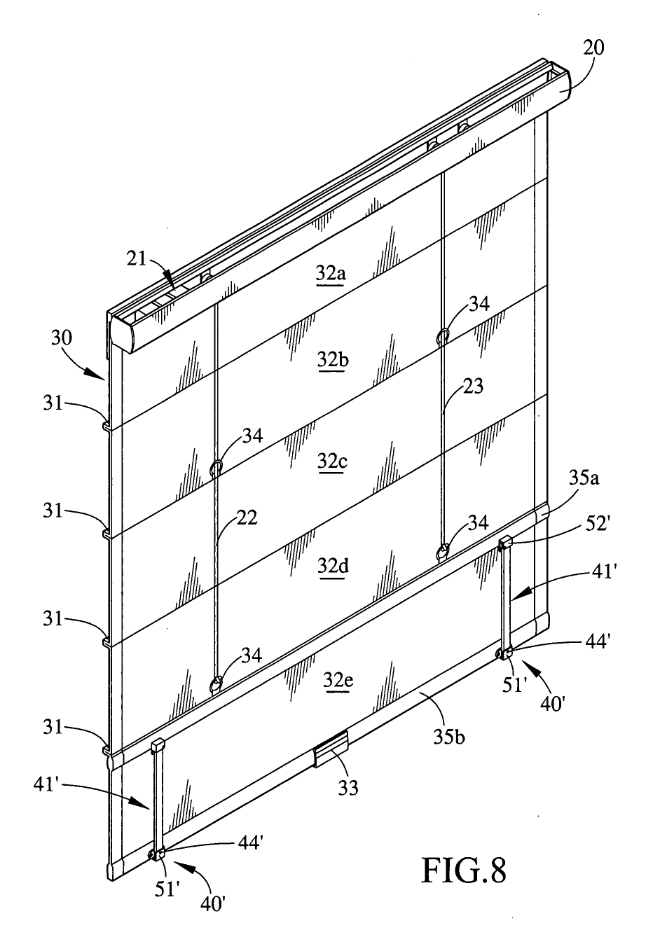

Please refer to FIGS. 7 and 8, in which a cordless Roman shade according to a second embodiment of the present invention is show. The cordless Roman shade in the second embodiment has an appearance, size, and configuration similar to that of the cordless Roman shade of the first embodiment shown in FIGS. 2 through 6. And, all the elements that are the same in the two embodiments are denoted by the same reference numerals. The second embodiment is different from the first embodiment in that a bracing system 40′ thereof is mounted on the lowest horizontal cell 32e in a direction reverse to the mounting direction of the bracing system 40 in the first embodiment. That is, the bracing system 40′ includes a brace 41′ and a fixing unit 50′. The fixing unit 50′ has a fixing seat 51′ mounted to the lower hem 35b of the cell 32e, and a receiving seat 52′ mounted to the upper hem 35a of the cell 32e.

The brace 41′ has a first end 42′ received in and connected via a supporting pin 44′ to an inner space 53′ defined in the fixing seat 51′, so that the brace 41′ is turnable about the supporting pin 44′ relative to the fixing seat 51′. When the brace 41′ is upward turned from a horizontal position as shown in FIG. 7 toward the receiving seat 52′, a second end 43′ of the brace 41′ is finally moved into an open slot 54′ on the receiving seat 52′. At this point, the brace 41′ longitudinally stretches open the cell 32e as shown in FIG. 8, so that the cell 32e possesses some extent of stiffness.

With the bracing system 40, 40′ and the tension lifting mechanism 21, a Roman shade may be lifted or lowered without the need of lift cords, which tend to cause safety problems and inconveniences in operating the Roman shade.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A cordless Roman shade, comprising a head rail internally provided with a tension lifting mechanism for providing a balancing force or a tension force, a shade connected at an upper portion to the head rail, a plurality of lines associated with the shade and controlled via the tension lifting mechanism to lift or lower the shade to a desired height, and at least one bracing system;
the shade including a plurality of horizontal cells from top to bottom, and a lowest one of the horizontal cells including an upper hem and a lower hem; and
the at least one bracing system being mounted on the lowest cell of the shade, and including a brace and a fixing unit;
the brace having a first end and a second end, and being connected at the first end to the lowest cell via a supporting pin, such that the brace is pivotally turnable about the supporting pin; and
the fixing unit including a receiving seat mounted on the lowest cell of the shade;
whereby when the brace is turned toward the receiving seat, the second end of the brace is finally engaged with the receiving seat, causing the brace to longitudinally stretch open the lowest cell to give the lowest cell some extent of stiffness; and when the stiffened lowest cell is subjected to an upward or downward force, the shade is lifted or lowered, respectively, under control of the tension lifting mechanism.

2. The cordless Roman shade as claimed in claim 1, wherein the first end of the brace is mounted to the upper hem of the lowest cell of the shade, and the receiving seat is mounted on the lower hem of the lowest cell of the shade.

3. The cordless Roman shade as claimed in claim 1, wherein the first end of the brace is mounted to the lower hem of the lowest cell of the shade, and the receiving seat is mounted on the upper hem of the lowest cell of the shade.

4. The cordless Roman shade as claimed in claim 1, wherein the shade is provided in the upper and the lower hem of the lowest cell with a rigid slat each.

5. The cordless Roman shade as claimed in claim 2, wherein the fixing unit further includes a fixing seat mounted to the upper hem of the lowest cell, and the first end of the brace is pivotally turnably received in and connected to the fixing seat via the supporting pin.

6. The cordless Roman shade as claimed in claim 3, wherein the fixing unit further includes a fixing seat mounted to the lower hem of the lowest cell, and the first end of the brace is pivotally turnably received in and connected to the fixing seat via the supporting pin.

7. The cordless Roman shade as claimed in claim 1, wherein the shade further includes a bracket, which is engaged at an upward opening with the lower hem of the lowest cell of the shade, such that a user may grip at the bracket to lift or lower the shade when the lowest cell is stretched open by the brace.

8. The cordless Roman shade as claimed in claim 1, wherein the shade is associated with at least one row of lift rings, and the lines controlled by the tension lifting mechanism are downward extended through the row of lift rings to fasten to a lowest lift ring in the row.
